(19) United States
(12) Patent Application Publication
(10) Pub. No.: US 2017/0155742 A1
(43) Pub. Date: Jun. 1, 2017

(54) DATA PROCESSING METHOD AND DEVICE

(71) Applicants: LE HOLDINGS (BEIJING) CO., LTD., Beijing (CN); LE SHI ZHI XIN ELECTRONIC TECHNOLOGY (TIANJIN) LIMITED, Tianjin (CN)

(72) Inventor: Pengyu Guo, Tianjin (CN)

(21) Appl. No.: 15/246,393

(22) Filed: Aug. 24, 2016

Related U.S. Application Data
(63) Continuation of application No. PCT/CN2016/089094, filed on Jul. 7, 2016.

(30) Foreign Application Priority Data
Nov. 26, 2015 (CN) 201510846760.9

(51) Int. Cl. H04L 29/06; H04L 29/08

(52) U.S. Cl. CPC H04L 67/42; H04L 67/025

(57) ABSTRACT

An embodiment of the present disclosure discloses a data processing method and device. The method comprises: sending a state request to a server such that the server inquires the state information of an associated user of a source user according to the state request; receiving a feedback message from the server, and determining display of an interaction identifier in a smart TV according to the state information in the feedback message; receiving interaction information of the associated user forwarded by the server, wherein the associated user is in the target state; and updating the interaction identifier according to the interaction information. Thus, two smart TVs at different places can perform information interaction to realize interaction.

### CROSS-REFERENCE TO RELATED APPLICATIONS

The present disclosure is a continuation of International Application No. PCT/CN2016/089094 filed on Jul. 7, 2016, which is based upon and claims priority to Chinese Patent Application No. 201510846760.9, entitled “DATA PROCESSING METHOD AND DEVICE”, filed to the State Intellectual Property Office of The P.R.C on Nov. 26, 2015, the entire contents of all of which are incorporated herein by reference.

### TECHNICAL FIELD

The present disclosure generally relates to the field of smart TV, in particular to a data processing method and a data processing device.

### BACKGROUND

Television is also called TV signal receiver, which transmits dynamic visual images in time by electric means. Along with the development of science and technologies, TV have been developed from the black-and-white model from the color model, and to existing network smart TVs. Smart TVs can play broadcast TV channels, and can also play network videos, and execute various network operations such as browsing webpages.

Therefore, users usually have a rest by means of watching TV programs in leisure. Different users usually watch the same TV programs in leisure. For example, after getting off work and in the weekend, people at different places may watch TV at the same time.

### SUMMARY

An embodiment of the present disclosure discloses a data processing method and a data processing device to solve problems of failure to interaction between two TVs in the prior art.

According to one aspect of the present disclosure, an embodiment of the present disclosure discloses a data processing method, including: sending a state request to a server such that the server inquires the state information of an associated user of a source user according to the state request; receiving a feedback message from the server, and determining display of an interaction identifier in a smart TV according to the state information in the feedback message; receiving interaction information of the associated user forwarded by the server, wherein the associated user is in the target state; and updating the interaction identifier according to the interaction information.

Correspondingly, according to another aspect of the present disclosure, an embodiment of the present disclosure also discloses a smart TV for data processing, including: at least one processor; and a memory communicably connected with the at least one processor for storing instructions executable by the at least one processor, wherein execution of the instructions by the at least one processor causes the at least one processor to: send a state request to a server such that the server inquires the state information of an associated user of a source user according to the state request; receive a feedback message from the server, and determine display of an interaction identifier in a smart TV according to the state information in the feedback message; receive interaction information of the associated user forwarded by the server, wherein the associated user is in the target state; and update the interaction identifier according to the interaction information.

According to another aspect of the present disclosure, the present discloses a computer program, including computer readable codes, wherein the computer readable codes operate on a smart TV such that the smart TV executes the data processing method.

Another embodiment of the present disclosure discloses a non-transitory computer readable medium storing executable instructions that, when executed by a smart TV, cause the smart TV to: send a state request to a server such that the server inquires the state information of the associated user of a source user according to the state request; receive the feedback message from the server and determine display of the interaction identifier in the smart TV according to the state information in the feedback message; receive the interaction information of the associated user forwarded by the server, wherein the associated user is in the target state; and update the interaction identifier according to the interaction information.

The present disclosure has the following beneficial effects:

the embodiment of the present disclosure sends the state request to the server such that the server inquires the state information of the associated user of a source user according to the state request, receives the feedback message from the server, determines display of the interaction identifier in the smart TV according to the state information in the feedback message, receives the interaction information of the associated user forwarded by the server, wherein the associated user is in the target state, and updates the interaction identifier according to the interaction information. In this way, two smart TVs update the interaction identifier to fulfill the aim of information interaction.

The above description is a summary of the solution of the present disclosure. In order to more clearly describe the technical means of the present disclosure, the content of the description can be executed. Moreover, in order to ensure that the above and other objectives, characteristics and advantages of the present invention more understandable, embodiments of the present disclosure are described below.

### BRIEF DESCRIPTION OF THE DRAWINGS

To more clearly describe the technical solution in the embodiments of the present invention or in the prior art, the following are brief introduction of the attached drawings used to describe the technology in the embodiments or in the prior art. Obviously, the attached drawings described below involve some embodiments of the present invention. For those originally skilled in this field, other drawings can be made according to those drawings without creative labor.

FIG. 1 is a step flowchart of a data processing method according to one embodiment of the present disclosure.

FIG. 2 is a step flowchart of a first data processing method according to another embodiment of the present disclosure.

FIG. 3 is a step flowchart of a second data processing method according to another embodiment of the present disclosure.

FIG. 4 is a step flowchart of a third data processing method according to another embodiment of the present disclosure.

FIG. 5 is a scene schematic diagram of a data processing application according to one embodiment of the present disclosure.

FIG. 6 is a structural block diagram of a data processing device according to one embodiment of the present disclosure.

FIG. 7 is a structural block diagram of a data processing device according to another embodiment of the present disclosure.

FIG. 8 schematically illustrates a block diagram of a smart TV for executing the method according to the present disclosure.

FIG. 9 schematically illustrates a memory cell for holding or carrying program codes for realizing the method according to the present disclosure.

### DETAILED DESCRIPTION

To make the objectives, technical solutions and advantage of the embodiments of the present disclosure more clear, the technical solutions in embodiments of the present disclosure are clearly and completely described below with reference to drawings in the embodiments of the present disclosure. Obviously, the described embodiments are some embodiments of the present disclosure, not all the embodiments of the present disclosure. Based on the embodiments in the present disclosure, those ordinarily skilled in this field can obtain other embodiments without creative labor, which all shall fall within the protective scope of the present disclosure.

### Embodiment 1

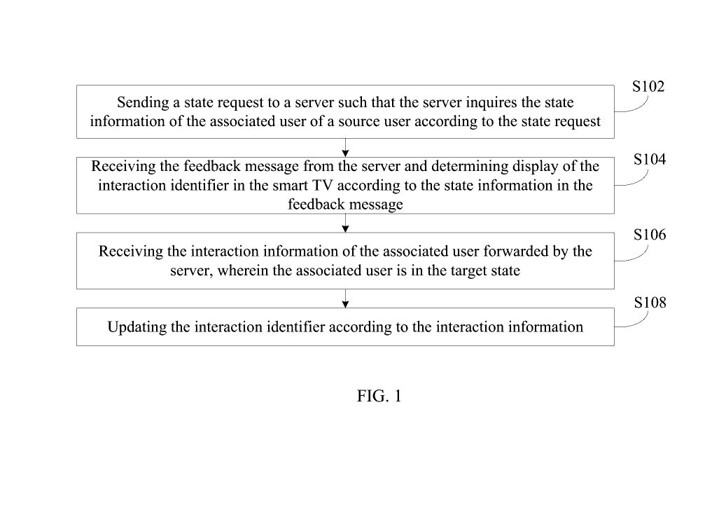

Refer to FIG. 1, which illustrates a step flowchart of a data processing method according to one embodiment of the present disclosure. The method may specifically include the steps as follows.

Step S102: send a state request to a server such that the server inquires the state information of the associated user of a source user according to the state request.

A user usually acquires whether the associated user watches TV through using communication tools such a telephone or social software; if people work for away, their parents at home fail to get the information about whether their children watch TV or not only through TV in the process of watching TV; and for two users who watch TV at the same time, information interaction through the smart TVs fails.

The embodiment of the present disclosure allows associated users who watch the smart TVs at the same time to perform interaction through the smart TVs.

In the process of watching TV, the source user logs in an account, for example a Letv account, the corresponding server will change the state of the source user to be on line, sends a state request to the server, inquires the state information of the associated user according to the state request, generates a feedback message according to the inquired result, and sends the feedback message to the source user.

Wherein, the source user is associated with a user to be associated in advance. In order to reduce effects on watching TV, every user can be associated with only one user. Of course, a plurality of associated users can be set through changing configurations, and every user is marked with a special identifier.

Step S104: receive the feedback message from the server and determines display of the interaction identifier in the smart TV according to the state information in the feedback message.

The server feeds the current state of the associated user to the source user. The associated user has at least two states, on-line and off-line. After receiving the feedback message, the source user determines the display of the interaction identifier in the smart TV according to the feedback message, wherein the display of the interaction identifier includes display of different states of the associated user, for example, display of the on-line state, or display of the off-line state of the associated user.

When the associated user is on line, the interaction identifier in the smart TV is displayed in form of a suspending icon, and the suspending icon is fluorescent and semi-transparent. In order to prompt the source user, the suspending icon can flash at a low frequency for a while, then flashes for 1 min in a breathing light mode, and finally keep normally on in yellow. When the associated user is off line, the interaction identifier in the smart TV is displayed in form of the suspending icon, and the color of the suspending icon is gray.

Step S106: receive the interaction information of the associated user forwarded by the server.

The server can receive the interaction information of the source user or the associated user, and after receiving the interaction information, the server sends the interaction information to the user at another terminal in a way of searching ID.

If the feedback message received from the server includes the on-line situation of the associated user, which means that the associated user is in the target state, the server forwards the interaction information to the source user when receiving the interaction information sent by the associated user.

Step S108: update the interaction identifier according to the interaction information.

The smart TV of the source user receives the interaction information forwarded by the server, wherein the interaction information is sent by the associated user, and the smart TV of the source user updates the interaction identifier according to the interaction information after receiving the interaction information, namely updating the suspending icon, wherein the update of the suspending icon includes various modes, for example color change, flash change, icon change, etc.

If the color of the suspending icon turns from yellow into pink and the suspending icon flashes within 5 min after the smart TV of the source user receives the interaction information for the first time, the suspending icon finally keeps normally on in pink.

The embodiment of the present disclosure sends the state request to the server such that the server inquires the state information of the associated user of a source user according to the state request, receives the feedback message from the server, determines display of the interaction identifier in the smart TV according to the state information in the feedback message, receives the interaction information of the associated user forwarded by the server, wherein the associated user is in the target state, and updates the interaction identifier according to the interaction information. In this way, two smart TVs update the interaction identifier to fulfill the aim of information interaction.

### Embodiment 2

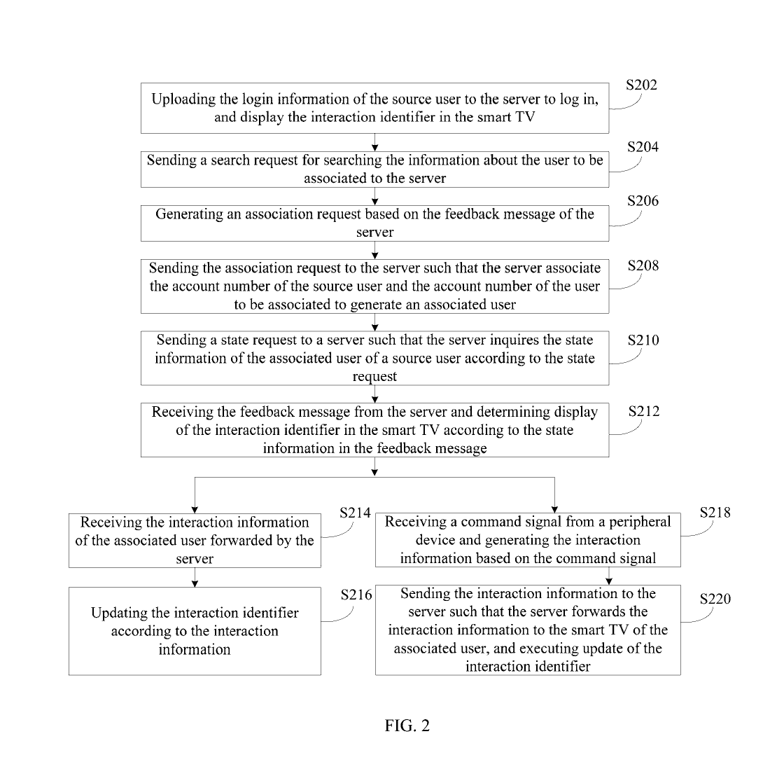

Refer to FIG. 2, which illustrates a step flowchart of the first data processing method according to another embodiment of the present disclosure. The method may specifically include the following steps.

Step S202: upload the login information of the source user to the server to log in, and display the interaction identifier in the smart TV.

The user can log in the smart TV application through the login information of the source user, for example ID login mode and Letv member login are possible; and the account information of the user can be set, including contents such as user gender, signature, head portrait, etc., and after the setting is completed, the server will register the settings.

After the login account number is uploaded to the server, the server checks the account information of the source user; if the account information passes the check, the sever sends a pass command, and the application in the smart TV of the corresponding user terminal is started; after the startup of the application, the interaction identifier is displayed on the side of the smart TV in form of a suspending icon; and the position of the suspending icon can be set through a periphery device, for example the suspending icon is moved up and down, left and right by using a remote controller.

The application in the TV, namely the interaction identifier, can be started in many ways including: startup through account number login, automatic startup when the smart TV is turned on, and startup with the startup command sent by a peripheral device.

Step S204: send a search request for searching the information about the user to be associated.

Step S206: generate an association request based on the feedback message of the server.

Step S208: send the association request to the server such that the user associate the account number of the source user and the account number of the user to be associated to generate an associated user.

Based on the user login information of the user to be associated, for example the ID number of the associated user, the source user sends a search request for searching the account information of the associated user; the server searches the account information of the user to be associated in the database according to the search request, and sends the account information as the feedback message to the source user; the source user checks the information of the user to be associated according to the feedback message, and if the information passes the check, generates an association request according to the information of the user to be associated, namely sending the request of the user to be associated for being set as the associated user of the source user to the server.

After receiving the association request of the source user, the server set to associate the user to be associated with the source user such that the source user can perform interaction with the user to be associated, namely receiving and/or forwarding the interaction information through the server.

The above setting includes that the server records the ID of the two accounts and sets the two users as associated accounts through the ID.

Wherein, the source user is associated with a user to be associated in advance. In order to reduce effects on watching TV, every user can be associated with only one user. Of course, a plurality of associated users can be set through changing configurations, and every user is marked with a special identifier.

Step S210: send a state request to a server such that the server inquires the state information of the associated user of a source user according to the state request.

After logging in the smart TV terminal, the source user can send a state request for inquiring the current state of the associated user; the server can inquire the current state information, namely on-line state or off-line state, of the associated user of the source user according to the state request.

Step S212: receive the feedback message from the server and determines display of the interaction identifier in the smart TV according to the state information in the feedback message.

When the associated user of the source user is currently in the on-line state, the server sends an on-line feedback to the source user, sends a message that the source user is also currently on line to the associated user of the source user; the interaction identifiers in the smart TVs in the corresponding two user terminals, namely the suspending icons, show on line, for example, the suspending icons are fluorescent and semi-transparent, and flashes for a period of time at a low frequency or flashes for 1 min in a breathing light mode, and finally keeps normally on in yellow.

When the associated user of the source user is currently in the off-line state, the server sends an off-line feedback to the source user; correspondingly, the interaction identifier in the smart TV of the source user terminal, namely the suspending icon, displays the off-line state, for example, the color of the suspending icon is gray.

Step S214: receive the interaction information of the associated user forwarded by the server.

Step S216: update the interaction identifier according to the interaction information.

After it is determined that the two users are both on line, the two users can perform information interaction; for example, the source user receives the interaction information from the associated user.

The associated user sends the interaction information to the source user. The associated user sends the interaction information to the server first; then, the server forwards the interaction information to the source user; and after the interaction information, the source user updates the interaction identifier according to the interaction information.

Wherein, updating the interaction identifier includes at least one operation below:

changing the color of the suspending icon from a first color to a second color, enabling the suspending icon to flash in a preset time, or changing the suspending icon.

For example, a loop program, N colors and a unit time S are defined; the program is triggered after receiving the interaction information; after the interaction information is received for the first time, the color of the suspending icon changes from the first color into the second color, and the suspending icon flashes in a unit time S and finally keeps normally on in the second color; after the interaction information is received for the second time, color of the suspending icon changes from the second color into a third color, and the suspending icon flashes in a unit time S and finally keeps normally on in the third color; followed by looping.

For example, yellow, pink and green colors are defined, while the unit time is defined as 5 min, wherein after the interaction information is received for the first time, the color of the suspending colors changes from yellow into pink, and the suspending icon flashes within 5 min and finally keeps normally on in pink; after the interaction information is received for the second time, the color of the suspending icon changes from pink into green, and the suspending icon flashes in 5 min and finally keeps normally on in green; after the interaction information is received for the third time, the color of the suspending icon changes from green into yellow, and the suspending icon flashes in 5 min and finally keeps normally on in yellow; followed by looping.

For example again, N suspending icons are preset; after the interaction information is received, the N suspending icons are circularly updated in turn according to the interaction information. For example, a figure icon, a star icon and round icon are set; when the interaction information is received for the first time, the suspending icon is changed from the figure icon into the star icon; when the interaction information is received for the second time, the suspending icon is changed from the star icon into the round icon; and when the interaction information is received for the third time, the suspending icon is changed from the round iron into the figure icon; followed by looping.

Step S218: receive a command signal from a peripheral device and generate interaction information based on the command signal.

Step 220: send the interaction information to the server such that the server forwards the interaction information to the smart TV of the associated user, and execute update of the interaction identifier.

After it is determined that the two users are both on line, the two users can perform information interaction; for example, the source user sends the interaction information to the associated user.

The source user sends the command signal to an application of the smart TV of the peripheral device, wherein the signal command signal is used for information interaction between the source user and the associated user of the source user; the application of the smart TV converts the command signal into the interaction information and sends the interaction information to the user; and the server forwards the interaction information to the application of the smart TV of the associated user of the source user through the associated ID numbers of the two users.

The application of the smart TV of the associated user displays the interaction information through the interaction identifier. See the specific step in Step S216.

Wherein, the peripheral device can include mobile devices such as the remote controller, mobile phone and tablet PC, for example, the remote controller is preset with a “family affection key” for sending the interaction command, or the mobile phone is equipped with an APP to send the interaction command through the APP.

According to an optimal solution of the embodiment of the present disclosure, the “family affection key” for sending the interaction command can be associated with the keys with other operation functions of the peripheral device, so the user can trigger other functional keys to send the interaction command together when operating the smart TV.

For example, the switch key and volume key of the remote controller are respectively associated with the “family affection key”, and it is proved that the user is in front of the smart TV as long as the user switches the channels or adjusts the volume; the interaction command is sent to the smart TV at the same time, and the smart TV forward the interaction command during channel switching or volume adjustment, thus fulfilling the objective that the two users perform information interaction through the smart TV.

The embodiment of the present disclosure can receive the interaction information and sends the interaction information to the opposite party at the same time, and the information interaction between the two users is implemented through at least one of the three modes of updating the interaction identifier, so the user can know that the opposite party is on-line through the interaction identifier, thus fulfilling the objective that the two smart TVs can perform information interaction through updating the interaction identifier.

If children are not with their parents, the smart TV of the two user terminals can be equipped with the application of the embodiment of the present disclosure such that children and parents can establish an information interaction platform; then, the peripheral device such as the remote controller is used to send the interaction command to the application, while the application converts the interaction command into the interaction information and sends the interaction information to the server; the server forwards the interaction information to the application in the smart TV of the other terminal; after receiving the interaction information, the application updates the interaction identifier in a way of color change, flash change, or change of the suspending icon, and then parents feel that children are close, thus making family members get closer.

### Embodiment 3

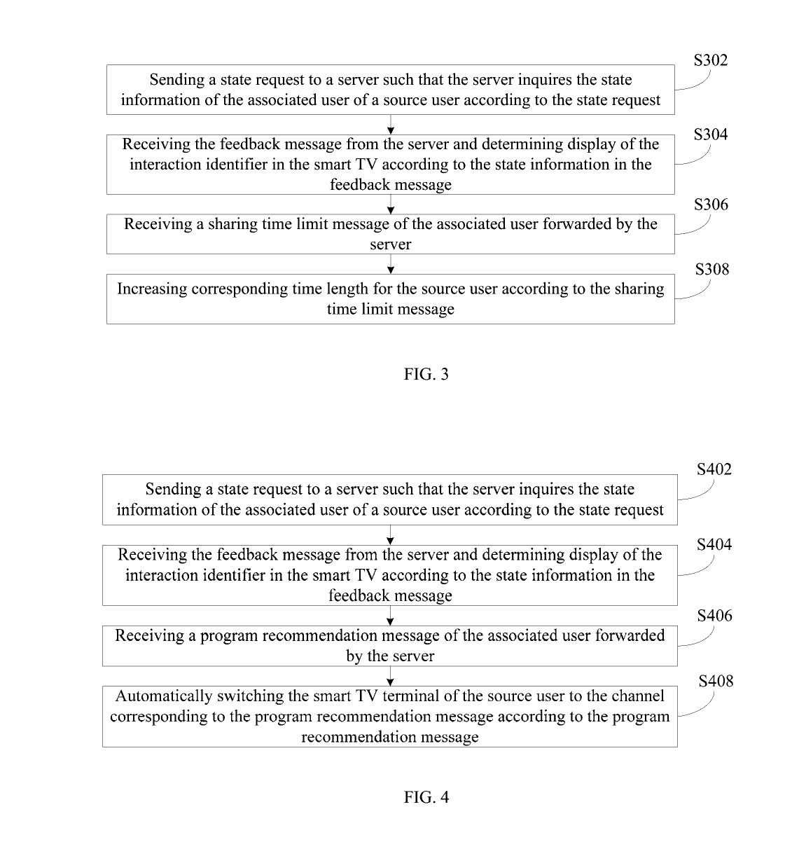

Refer to FIG. 3, which illustrates a step flowchart of the second data processing method according to another embodiment of the present disclosure. The method may specifically include the following steps.

Step S302: Send a state request to a server such that the server inquires the state information of the associated user of a source user according to the state request.

Step S304: Receive the feedback message from the server and determines display of the interaction identifier in the smart TV according to the state information in the feedback message.

The above steps are basically consistent with the operation steps in the first or second embodiment, and therefore are not repeatedly described here.

Step S306 Receive a sharing time limit message of the associated user forwarded by the server.

The associated user sends the sharing time limit command to the application of the smart TV of the associated user through a peripheral device, for example a mobile phone or a remote controller, and application of the smart TV converts the sharing time limit command into a sharing time limit message and sends the sharing time limit message to the sever.

The server receives the sharing time limit message sent by the associated user, namely sharing own time length with the source user, for example the time length of Letv membership. The server analyzes the sharing time limit message after receiving sharing time limit message, obtains the sharing time length corresponding to the sharing time limit message, and searches the time length owned by the associated user itself according to the sharing time length; if the sharing time length does not exceed the time length owned by the associated user itself, the server forwards the sharing time limit message to the source user; and if the sharing time length exceeds the time length owned by the associated user itself, the sharing time limit message fails and is fed back to the associated user, and the associated user determines the sharing time limit message again.

The application of the smart TV of the source user receives the sharing time limit message forwarded by the server; after receiving the sharing time limit message, the screen of the smart TV shows the options “Agree” and “Not Agree”, and the source user can use a peripheral device to make a choice between the two options.

Step S308: increase corresponding time length for the source user according to the sharing time limit message.

After the source user selects the “Agree” option, the server searches the time length owned by the source user currently according to the sharing time limit message, for example the membership time length, and allocates the sharing time length corresponding to the sharing time limit message to the source user; the source user is increased with the corresponding time length, and then the last residual time length of the source user is obtained.

The server searches the time length owned by the associated user currently according to the sharing time limit message, and reduces the corresponding time length of the associated user according to the sharing time limit corresponding to the sharing time limit message, and then the last residual time length of the associated user is obtained.

If the source user selects the “Not Agree” option, an interaction failure message is sent to the server, and the server sends the message “Fail to share the time limit” to the associated user, and displays the message “Fail to share the time limit” on the smart TV terminal of the associated user.

The embodiment of the present disclosure adds the sharing time limit message to the interaction information such that the two users can complete the sharing of the time limit through the server, perform identifier interaction in the set time limit sharing process, and represents information interaction through flashing or changing color.

### Embodiment 4

Refer to FIG. 4, which illustrates a step flowchart of the third data processing method according to another embodiment of the present disclosure. The method may specifically include the following steps.

Step S402: Send a state request to a server such that the server inquires the state information of the associated user of a source user according to the state request.

Step S404: Receive the feedback message from the server and determines display of the interaction identifier in the smart TV according to the state information in the feedback message.

The above steps are basically consistent with the operation steps in the first and second embodiments, and therefore are not repeatedly described here.

Step S406 Receive a program recommendation message of the associated user forwarded by the server.

The associated user sends a film and TV series recommendation command to the application of the smart TV of the associated user through a peripheral device, for example a mobile phone or a remote controller, and application of the smart TV converts the film and TV series recommendation into a program recommendation message and sends the program recommendation message to the sever, wherein the program recommendation message includes channels information corresponding certain TV series, certain films, certain news programs, and certain entertainment programs.

The sever receives the program recommendation message sent by the associated user and forwards the program recommendation message to the application of the smart TV of the source user, and the application of the smart TV of the source user receives the program recommendation message forwarded by the server.

Step S408: Automatically switch the smart TV terminal of the source user to the channel corresponding to the program recommendation message according to the program recommendation message.

The application of the smart TV of the source user analyzes the program recommendation message to obtain recommended programs and recommended channels in the program recommendation message, displays the recommended programs and recommended channels on the smart TV to the source user, and let the source user select the “Agree” or “Not Agree” option; when the source user selects the “Agree” option, the smart TV switch to the recommended channel according to the program recommendation message, and then the source user can watch the recommended programs in the recommended channel.

For example, the associated user watches the “Legend of Zhen Huan” played by Beijing TV, and the associated user wants to recommend to this TV series played by the Beijing TV to the source user. The associated user uses a peripheral device sends the “Legend of Zhen Huan” and “Beijing TV” which are used as the command information to the application of the smart TV of the associated user; the application converts the command information into the program recommendation message and sends the program recommendation message to the server; the server forwards the program recommendation message to the application of the smart TV of the source user; the application of the smart TV of the source user analyzes the program recommendation message to obtain “Legend of Zhen Huan” and “Beijing TV”; if the source user selects “Agree” option, the application of the smart TV terminal switches to Beijing TV station according to the program recommendation message, and the source user can watch the “Legend of Zhen Huan” played by Beijing TV.

If the source user selects the “Not Agree” option, an interaction failure message is sent to the server, and the server sends the message “Fail to recommend programs” to the associated user, and displays the message “Fail to recommend programs” on the smart TV of the associated user.

According to the embodiment of the present disclosure, two users are associated and are on line at the same time; one can edit the program information and channel information through the peripheral device and sends the information to the application of the smart TV thereof, and the application forwards the information to the server; and the server forwards the information to the other, thus realizing recommendation of the TV programs.

It is needed to be noted that, for simple description, the method embodiments are described as a series of action combinations, but those skilled in this field understand that the embodiments of the present disclosure are not limited by the sequence of the described actions because according to the embodiments of the present disclosure, some steps can be implemented in other sequence or at the same time. Moreover, those skilled in this field also understand that the embodiments described in the present disclosure all belong to optimal embodiments, and some actions involved are not always needed by the embodiments of the present disclosure.

### Embodiment 5

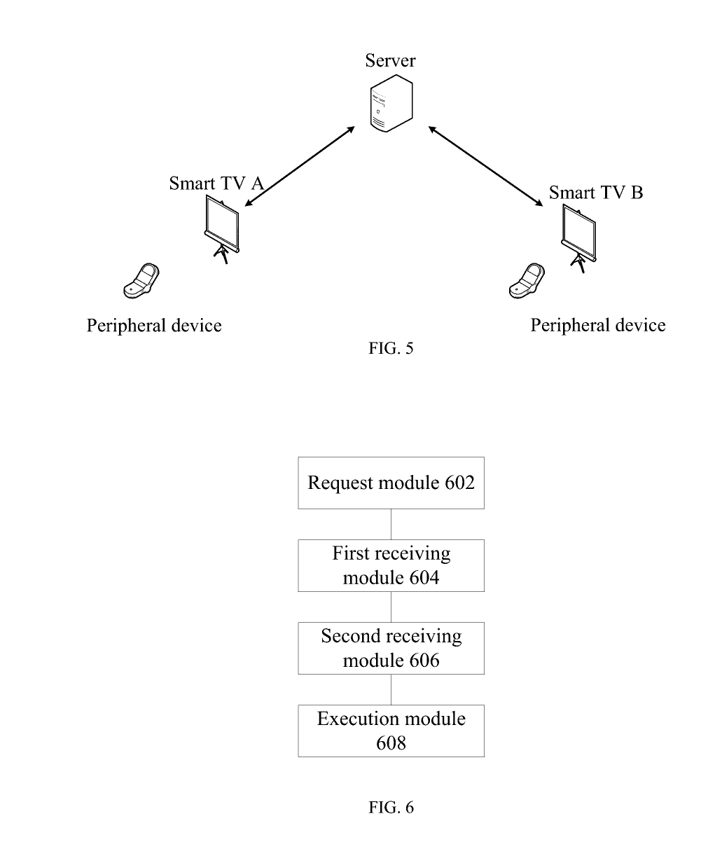

Refer to FIG. 5, which is a scene schematic diagram of a data processing application according to one embodiment of the present disclosure. The scene specifically includes:

a server, a smart TV A, a smart TV B and peripheral devices at the two smart TV terminals.

Wherein, the smart TV A starts the application, logs in with an account number, sends a search request to the server to request check of the login account number of the smart TV B, and adds the account number of the smart TV as an associated account number.

After the association is completed, the smart TV A continuously sends a state request to the server to request checking if the associated user is on line currently, which means if users at the smart TV B terminal watches TV currently; if so, the server sends an on-line feedback to the smart TV A, and the interaction identifier of the smart TV A displays that the opposite party is on line.

The smart TV A sends an interaction command to the application thereof through the peripheral device such a remote controller and a mobile phone; the application of the smart TV A converts the command into the interaction information and send the interaction information to the server; the server sends the interaction information to the smart TV B; and the smart TV B updates the interaction identifier after receiving the interaction information.

Based on the above steps, the information interaction between the smart TV A and the smart TV B can be implemented; on the contrary, the smart TV B can send the interaction information to the smart TV A based on the above steps to realize the information interaction between the smart TV A and the smart TV B.

The smart TV A can also send a sharing time limit command or a program recommendation command to the application thereof through the peripheral device such a remote controller or a mobile phone; the application of the smart TV A converts the command into the sharing time limit information or program recommendation information and send the information to the server; the server sends the sharing time limit information or program recommendation information to the smart TV B; and the smart TV B carries out corresponding operation after receiving the sharing time limit information or program recommendation information.

### Embodiment 6

Refer to FIG. 6, which illustrates a structural block diagram of a data processing device according to one embodiment of the present disclosure. The device may specifically include the following modules:

a request module 602 for sending a state request to a server such that the server inquires the state information of an associated user of a source user according to the state request; a first receiving module 604 for receiving a feedback message from the server, and determining display of an interaction identifier in a smart TV according to the state information in the feedback message; a second receiving module 606 for receiving interaction information of the associated user forwarded by the server, wherein the associated user is in the target state; and an execution module 608 for updating the interaction identifier according to the interaction information.

The embodiment of the present disclosure sends the state request to the server such that the server inquires the state information of the associated user of a source user according to the state request, receives the feedback message from the server, determines display of the interaction identifier in the smart TV according to the state information in the feedback message, receives the interaction information of the associated user forwarded by the server, wherein the associated user is in the target state, and updates the interaction identifier according to the interaction information. In this way, two smart TVs update the interaction identifier to fulfill the aim of information interaction.

The device embodiment is basically the same as the method embodiments and therefore is simply described. Related contents can be seen in the related description of the method embodiments.

### Embodiment 7

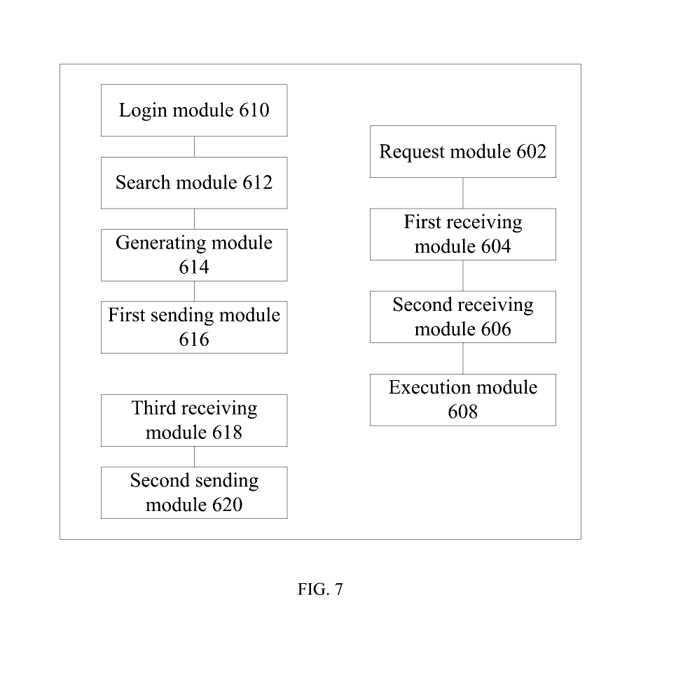

Refer to FIG. 7, which illustrates a structural block diagram of a data processing device according to another embodiment of the present disclosure. The device may specifically include the following modules.

A login module 610 for uploading the login information of the source user to the server to log in, and displaying the interaction identifier in the smart TV, wherein the interaction identifier comprises suspending icons; a search module 612 for sending a search request for searching the information about the user to be associated; a generating module 614 for generating an association request based on the feedback message of the server; a first sending module 616 for sending the association request to the server so that the user associate the account number of the source user and the account number of the user to be associated to generate an associated user.

A request module 602 for sending a state request to a server such that the server inquires the state information of an associated user of a source user according to the state request; a first receiving module 604 for receiving a feedback message from the server, and determining display of an interaction identifier in a smart TV according to the state information in the feedback message; a second receiving module 606 for receiving interaction information of the associated user forwarded by the server, wherein the associated user is in the target state; and an execution module 608 for updating the interaction identifier according to the interaction information.

A third receiving module 618 for receiving a command signal from a peripheral device and generating the interaction information based on the command signal; and a second sending module 620 for sending the interaction information to the server so that the server forwards the interaction information to the smart TV of the associated user, and executing update of the interaction identifier.

The second receiving module 606 is also used for receiving the sharing time limit message of the associated user forwarded by the server. The execution module 608 is also used for increasing corresponding time length for the source user according to the sharing time limit message.

The second receiving module 606 is also used for receiving a program recommendation message of the associated user forwarded by the server. The execution module 608 is also used for automatically switching the smart TV terminal of the source user to the channel corresponding to the program recommendation message according to the program recommendation message.

Wherein, the execution module includes at least one operation below: changing the color of the suspending icon from a first color to a second color, enabling the suspending icon to flash in a preset time, or changing the suspending icon.

The embodiment of the present disclosure can receive the interaction information and sends the interaction information to the opposite party at the same time, and the information interaction between the two users is implemented through at least one of the three modes of updating the interaction identifier, so the user can know that the opposite party is on-line through the interaction identifier, thus fulfilling the objective that the two smart TVs can perform information interaction through updating the interaction identifier.

The device embodiment described above is schematic, wherein units described as separable parts may be or may be not physically separated, and components displayed as modules may be or may be not physical modules, which means that the modules can be positioned at one place or distributed on a plurality of network modules. Some or all modules can be selected to fulfill the objective of the solution in the embodiment upon actual demands. Those ordinarily skilled in this field can understand and implement the present disclosure without creative work.

All embodiments of the present disclosures are described in a progressive manner. Every embodiment focuses on different factors. Identical and similar parts of the embodiments can be reference of one another.

Each of devices according to the embodiments of the disclosure can be implemented by hardware, or implemented by software modules operating on one or more processors, or implemented by the combination thereof. A person skilled in the art should understand that, in practice, a microprocessor or a digital signal processor (DSP) may be used to realize some or all of the functions of some or all of the modules in the device according to the embodiments of the disclosure. The disclosure may further be implemented as device program (for example, computer program and computer program product) for executing some or all of the methods as described herein. Such program for implementing the disclosure may be stored in the computer readable medium, or have a form of one or more signals. Such a signal may be downloaded from the internet websites, or be provided in carrier, or be provided in other manners.

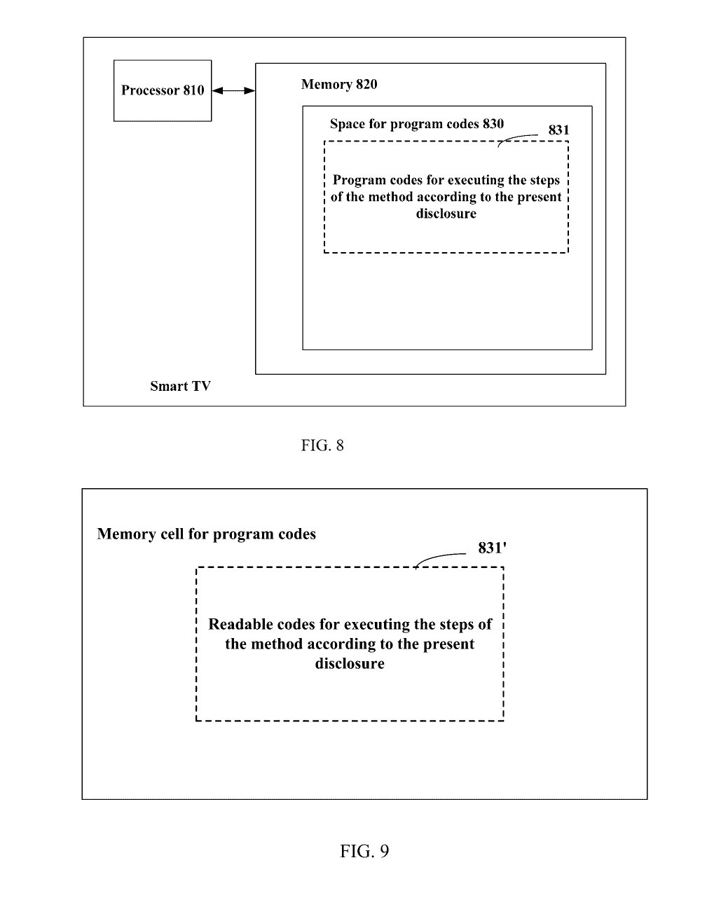

For example, FIG. 8 illustrates a block diagram of a smart TV for executing the data processing method according the disclosure. Traditionally, the smart TV includes a processor 810 and a computer program product or a computer readable medium in form of a memory 820. The memory 820 could be electronic memories such as flash memory, EEPROM (Electrically Erasable Programmable Read-Only Memory), EPROM, hard disk or ROM. The memory 820 has a memory space 830 for executing program codes 831 of any steps in the above methods. For example, the memory space 830 for program codes may include respective program codes 831 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG. 9. The memory cells may be provided with memory sections, memory spaces, etc., similar to the memory 820 of the server as shown in FIG. 8. The program codes may be compressed for example in an appropriate form. Usually, the memory cell includes computer readable codes 831′ which can be read for example by processors 810. When these codes are operated on the server, the server may execute respective steps in the method as described above.

The “an embodiment”, “embodiments” or “one or more embodiments” mentioned in the disclosure means that the specific features, structures or performances described in combination with the embodiment(s) would be included in at least one embodiment of the disclosure. Moreover, it should be noted that, the wording “in an embodiment” herein may not necessarily refer to the same embodiment.

Many details are discussed in the specification provided herein. However, it should be understood that the embodiments of the disclosure can be implemented without these specific details. In some examples, the well-known methods, structures and technologies are not shown in detail so as to avoid an unclear understanding of the description.

It should be noted that the above-described embodiments are intended to illustrate but not to limit the disclosure, and alternative embodiments can be devised by the person skilled in the art without departing from the scope of claims as appended. In the claims, any reference symbols between brackets form no limit of the claims. The wording “include” does not exclude the presence of elements or steps not listed in a claim. The wording “a” or “an” in front of an element does not exclude the presence of a plurality of such elements. The disclosure may be realized by means of hardware comprising a number of different components and by means of a suitably programmed computer. In the unit claim listing a plurality of devices, some of these devices may be embodied in the same hardware. The wordings “first”, “second”, and “third”, etc. do not denote any order. These wordings can be interpreted as a name.

Also, it should be noticed that the language used in the present specification is chosen for the purpose of readability and teaching, rather than explaining or defining the subject matter of the disclosure. Therefore, it is obvious for an ordinary skilled person in the art that modifications and variations could be made without departing from the scope and spirit of the claims as appended. For the scope of the disclosure, the publication of the inventive disclosure is illustrative rather than restrictive, and the scope of the disclosure is defined by the appended claims.

Those skilled in this field understand that the embodiments of the present disclosure can be provided methods, devices or computer program products. Therefore, the embodiments of the present disclosure can be complete hardware embodiments, complete software embodiments or embodiments in combination of software and hardware. Besides, the embodiments of the present disclosure can be one or more computer program products implemented in computer accessible storage media (including but not limited to magnetic disc memories, CD-ROM, optical memories, etc.) which contain program codes for computers.

The embodiments of the present disclosure are described with reference to the flowcharts and/or block diagrams of the methods and terminal devices and computer program products of the embodiments of the present disclosure. It should be understood that the computer program commands realize every process and/or block in the flowcharts and/or block diagrams and the combination of processes and/or blocks in the flowcharts and/or block diagrams. The computer program command can be supplied to the processor of a universal computer, a special computer, an embedded processing machine or other programmable data processing terminals to generate a machine, so the commands executed by the processor of the computer or other programmable data processing terminals generate a device for realizing specific functions in one or more processes in the flowcharts and/or one or more blocks in the block diagrams.

The computer program commands can also be stored in computer readable memories which guide the computer or other programmable data processing terminal devices to work in a specific mode, so the commands stored in the computer readable memories generate products including command devices, and the command devices conduct specific functions in one or more processes in the flowcharts and/or one or more blocks in the block diagrams.

The computer program commands can also be loaded in the computer or other programmable data processing terminal devices so that the computer or other programmable data processing terminal devices execute a series of operations to generate processing executed by the computer. Thus, the commands executed in the computer or other programmable data processing terminal devices supply processes of conducting specific functions in one or more processes in the flowcharts and/or one or more blocks in the block diagrams.

Although the optimal embodiments of the present disclosure are described, those skilled in this field can make other changes and modifications on those embodiments when getting the basic creative concept. Therefore, the protective scope of the claims includes the optimal embodiments and all changes and modifications within the embodiments of the present disclosure.

Finally, it is needed to be noted that, in the text, the relationship terms such as the “first” and the “second” are used for merely distinguishing an entity or operation from another entity or operation, and it is not always required or hinted that those entities or operation have such practical relationships or are in such sequences. Besides, the terms “comprise”, “include” or any other synonyms are intended to cover non-exclusive inclusion, so the processes, methods, articles or terminal devices of a series of elements include not only those elements, but also other elements, which are not clearly listed, or also include all inherent factors of those processes, methods, articles or terminals device. In the case of no more limit, the elements defined by the sentence “comprising/including a/an” should not exclude that the processes, methods, articles or terminal devices including the elements also include other identical elements.

The present disclosure describes a data processing method and a data processing device in detail. In the text, specific examples are used to describe the principle and implementation modes of the present disclosure. The above embodiments are used to describe instead of limiting the technical solution of the present disclosure; although the above embodiments describe the present disclosure in detail, those ordinarily skilled in this field shall understand that they can modify the technical solutions in the above embodiments or make equivalent replacement of some technical characteristics of the present disclosure; those modifications or replacement and the corresponding technical solutions do not depart from the spirit and scope of the technical solutions of the above embodiments of the present disclosure.

What is claimed is:

1. A data processing method, at a smart TV, comprising:
sending a state request to a server such that the server inquires the state information of the associated user of a source user according to the state request;
receiving the feedback message from the server and determining display of the interaction identifier in the smart TV according to the state information in the feedback message;
receiving the interaction information of the associated user forwarded by the server, wherein the associated user is in the target state; and
updating the interaction identifier according to the interaction information.

2. The method according to claim 1, wherein the method further comprises:
uploading the login information of the source user to the server to log in, and displaying the interaction identifier in the smart TV, wherein the interaction identifier comprises suspending icons.

3. The method according to claim 1, further comprising:
sending a search request for searching the information about the user to be associated, to the server;
generating an association request based on the feedback message of the server; and
sending the association request to the server such that the user associate the account number of the source user and the account number of the user to be associated to generate an associated user.

4. The method according to claim 1, wherein the updating the interaction identifier comprises at least one operation of:
changing the color of the suspending icon from a first color to a second color, enabling the suspending icon to flash in a preset time, or changing the suspending icon.

5. The method according to claim 1, wherein the method further comprises:
receiving a command signal from a peripheral device and generating the interaction information based on the command signal;
sending the interaction information to the server such that the server forwards the interaction information to the smart TV of the associated user, and executing update of the interaction identifier.

6. The method according to claim 1, wherein the method further comprises:
receiving the sharing time limit message of the associated user forwarded by the server, and increasing corresponding time length for the source user according to the sharing time limit message.

7. The method according to claim 1, wherein the method further comprises:
receiving a program recommendation message of the associated user forwarded by the server, and automatically switching the smart TV terminal of the source user to the channel corresponding to the program recommendation message according to the program recommendation message.

8. A smart TV for data processing, comprising:
at least one processor; and
a memory communicably connected with the at least one processor for storing instructions executable by the at least one processor, wherein execution of the instructions by the at least one processor causes the at least one processor to:
send a state request to a server such that the server inquires the state information of the associated user of a source user according to the state request;
receive the feedback message from the server and determine display of the interaction identifier in the smart TV according to the state information in the feedback message;
receive the interaction information of the associated user forwarded by the server, wherein the associated user is in the target state;
update the interaction identifier according to the interaction information.

9. The smart TV according to claim 8, wherein execution of the instructions by the at least one processor causes the at least one processor to:
upload the login information of the source user to the server to log in, and display the interaction identifier in the smart TV, wherein the interaction identifier comprises suspending icons.

10. The smart TV according to claim 8, wherein execution of the instructions by the at least one processor causes the at least one processor to:
send a search request for searching the information about the user to be associated;
generate an association request based on the feedback message of the server;
send the association request to the server such that the user associate the account number of the source user and the account number of the user to be associated to generate an associated user.

11. The smart TV according to claim 8 wherein update the interaction identifier according to the interaction information comprises at least one of:
change the color of the suspending icon from a first color to a second color, enable the suspending icon to flash in a preset time, or change the suspending icon.

12. The smart TV according to claim 8, wherein execution of the instructions by the at least one processor causes the at least one processor to:
receive a command signal from a peripheral device and generating the interaction information based on the command signal;
send the interaction information to the server such that the server forwards the interaction information to the smart TV of the associated user, and execute update of the interaction identifier.

13. The smart TV according to claim 8, wherein,
receive the interaction information of the associated user forwarded by the server comprises: receive the sharing time limit message of the associated user forwarded by the server;
and update the interaction identifier according to the interaction information comprises: increase corresponding time length for the source user according to the sharing time limit message.

14. The smart TV according to claim 8, wherein,
receive the interaction information of the associated user forwarded by the server comprises: receive the program recommendation message of the associated user forwarded by the server;
and update the interaction identifier according to the interaction information comprises: automatically switch the smart TV terminal of the source user to the channel corresponding to the program recommendation message according to the program recommendation message.

15. A non-transitory computer readable medium, storing executable instructions that, when executed by a smart TV, cause the smart TV to:
send a state request to a server such that the server inquires the state information of the associated user of a source user according to the state request;
receive the feedback message from the server and determine display of the interaction identifier in the smart TV according to the state information in the feedback message;
receive the interaction information of the associated user forwarded by the server, wherein the associated user is in the target state; and
update the interaction identifier according to the interaction information.

16. The non-transitory computer readable medium according to claim 15, wherein the smart TV is further caused to:
upload the login information of the source user to the server to log in, and displaying the interaction identifier in the smart TV, wherein the interaction identifier comprises suspending icons.

17. The non-transitory computer readable medium according to claim 15, wherein the smart TV is further caused to:
send a search request for searching the information about the user to be associated, to the server;
generate an association request based on the feedback message of the server; and
send the association request to the server such that the user associate the account number of the source user and the account number of the user to be associated to generate an associated user.

18. The non-transitory computer readable medium according to claim 15, wherein the update the interaction identifier comprises at least one operation of:
change the color of the suspending icon from a first color to a second color, enabling the suspending icon to flash in a preset time, or changing the suspending icon.

19. The non-transitory computer readable medium according to claim 15, wherein the smart TV is further caused to:
receive a command signal from a peripheral device and generate the interaction information based on the command signal;
send the interaction information to the server such that the server forwards the interaction information to the smart TV of the associated user, and execute update of the interaction identifier.

20. The non-transitory computer readable medium according to claim 15, wherein the smart TV is further caused to:
receive the sharing time limit message of the associated user forwarded by the server, and increase corresponding time length for the source user according to the sharing time limit message.
